(19) United States
(12) Patent Application Publication
(10) Pub. No.: US 2013/0283288 A1
(43) Pub. Date: Oct. 24, 2013

(54) SYSTEM RESOURCE CONSERVING METHOD AND OPERATING SYSTEM THEREOF

(71) Applicant: WISTRON NEWEB CORP., Hsinchu (TW)

(72) Inventors: Ching-Jung CHEN, Hsinchu (TW); Yung-Fa HO, Hsinchu (TW)

(73) Assignee: Wistron NeWeb Corp., Hsinchu (TW)

(21) Appl. No.: 13/868,616

(22) Filed: Apr. 23, 2013

(30) Foreign Application Priority Data
Apr. 24, 2012 (TW) 101114512

(51) Int. Cl. G06F 9/50

(52) U.S. Cl. CPC G06F 9/50
USPC 718/104

(57) ABSTRACT

A system resource conserving method for managing an application process executing on an electronic device, wherein the electronic device has a combination of system resources, the method comprising: (A) executing a central management process for managing utilization of the system resource by the application processes; (B) receiving by the central management process a task completion message from one of the application processes; and (C) selectively transmitting by the central management process a terminate message or a suspend message to the application process according to the task completion message in order to terminate or suspend the execution of the application process such that the application process stops using the system resources.

### BACKGROUND OF THE INVENTION

1. Field of the Invention

The present invention relates to a system resource conserving method for an electronic device and an operating system using the method thereof; particularly, the present invention relates to a method of management of application processes to conserve system resources in an electronic device and the operating system using the method thereof.

2. Description of the Related Art

Presently, the majority of electronic products having processors typically operate using an operating system. A typical operating system, Linux for example, includes a kernel space and a user space. User space is primarily used to execute processes of application programs, whereas kernel space is used to control and schedule the time and system resources of the executing processes, such as the system resource usages of the processor and memory. When application processes are first executed in the user space, they typical use the resources of the operating system through the kernel space.

Typically, application processes are not terminated or suspended after they have completed their tasks. Under these circumstances, although their tasks have been accomplished, the application processes will maintain their “ready” statuses until the next scheduled time set by the scheduler unit of the kernel space for re-executing the application processes arrives. However, in the period of time that the application processes are in the “ready” state, system resources will continually be occupied as long as the application processes are still executing, wasting the electronic device's power while preventing the occupied resources of the virtual memory from being released and redistributed for use to other application processes.

In addition, if application processes have already completed its last task, they will continually occupy the system resources and the electronic device will waste energy. In order to overcome these problems, many people have suggested executing a monitor in the user space to periodically scan the user space for application processes that are executing such that system resources may be released. However, when the number of application processing executing in the user space is large, this method of periodically scanning the user space is time and resource consuming. In addition, since it is periodically executed, this method is still not able to completely solve the problem of application processes that are wasting energy while they occupy system resources during “ready” states.

As such, as technology improves and the needs and demands of consumers increases for every sort of electronic products on the market, the competition between manufacturers are also increasing daily. To differentiate their products from competitors, manufacturers of each electronic product will start to present products with more features or storage capacities. However, this also conversely means that even more application processes are not being terminated or suspended, causing even more waste in system resources and energy.

### SUMMARY OF THE INVENTION

It is an object of the present invention to provide a system resource conserving method that can decrease system resource and energy waste.

it is another object of the present invention to provide a system resource conserving method that can manage application processes executing in user spaces.

It is yet another object of the present invention to provide a system resource conserving method that can manage the start up, suspension, and termination of application processes in real-time so as to decrease system resource and energy waste.

The present invention provides a system source conserving method for managing an application process executing on an electronic device, wherein the electronic device has a combination of system resources. The system resource conserving method includes: executing a central management process for managing utilization of the system resource by the application processes; receiving by the central management process a task completion message from one of the application processes; and selectively transmitting by the central management process a terminate message or a suspend message to the application process according to the task completion message in order to terminate or suspend the execution of the application process such that the application process stops using the system resources.

The present invention provides an operating system for use in an electronic device, wherein the electronic device includes a combination of system resources. The operating system includes a user space and a kernel space. At least an application process and a central management process are executed in the user space, wherein the central management process receives from one of the application process a task completion message, and according to the task completion message selectively transmits a terminate message or a suspend message to the application process to terminate or suspend the execution of the application process. The kernel space is for distributing a portion of the system resource combination for the application process to use, wherein according to the terminate message or the suspend message the application process notifies the kernel space of the termination or suspension of the application process so that the portion of the system resource combination in use by the application process is released.

### BRIEF DESCRIPTION OF THE DRAWINGS

FIG. 1 is a view the structure of the operating system of the present invention;

FIG. 2 is flow diagram of the system resource conserving method;

FIG. 3 is another embodiment of the system resource conserving method;

FIG. 4A is another embodiment of the system resource conserving method; and

FIG. 4B is another embodiment of the system resource conserving method.

### DETAILED DESCRIPTION OF THE PREFERRED EMBODIMENT

The present invention provides a system resource conserving method, preferably for use in an electronic device having an operating system, wherein the electronic device may be handheld smart electronic products, routers, or any other computer systems related electronic devices. The operating system preferably is a real time operating system (RTOS), such as Linux or Microsoft Windows operating systems. However, in other different embodiments, the operating system may be of other different operating systems.

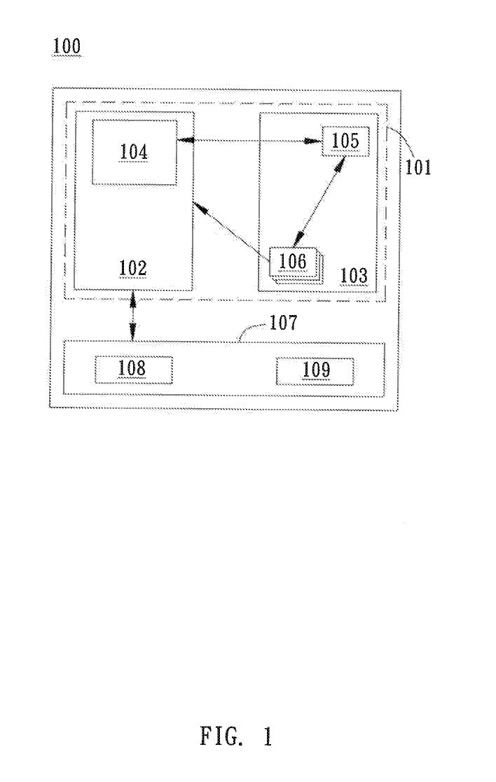

Please refer to FIG. 1 of a structural diagram of the present invention. In the present embodiment, the electronic device 100 includes the operating system 101 and system resource combination 107. The system resource combination 107, for example, includes data processor 108 and storage unit 109. The storage unit 109 may be a hard drive, a random access memory, or any other units for storage. It should be noted that system resources are not limited to data processor 108, storage unit 109 or their combination, as one skilled in the related art can easily understand that the system resource can also include any resource that can be used by the operating system, such as system resources like internet interface controllers. In addition, please also note that the system resource combination 107 may only include a single system resource. As shown in FIG. 1, the operating system 101 can be grouped into a kernel space 102 and a user space 103. Typically, programs are stored in the storage unit 109. When users wish to start the execution of a particular program, the operating system 101 will execute the application process 106 of the program in the user space 103. When the application process 106 is first executed in the user space 103, the application process 106 will request of the kernel space 102 through sending a system call to control and schedule the execution time and system resources of the application process 106. In other words, the application process 106, through system calls, indirectly requests of the kernel space 102 to distribute time and system resources to the application process 106 to use. For instance, when kernel space 102 receives the system call from the application process 106, the kernel space 102 will typically distribute at least a portion of a virtual memory to the application process 106.

As shown in FIG. 1, a central management process 105 is provided, wherein the main purpose of the central management process 105 is to manage the suspension, termination, and re-execution of application processes 106 in the user space 103. The central management process 105 executes independently from the other application processes 106. In more definite terms, application processes executing in the user space 103 are typically independently executed. After first execution and completion of task, application processes 106 will first transmit a task completion message to the central management process 105. In the present embodiment, the task completion message includes the re-execution time of the application process 106, as well as data on the current state of the application process 106. Since each application process 106 executing in the user space 103 each have different purposes or tasks, not every application process 106 should be suspended or terminated at they have completed their tasks; Otherwise, the suspension or termination of certain application processes 106 may result in unforeseeable consequences in the system. Therefore, when the central management process 105 receives the task completion message from the application process 106, the central management process 105 will transmit a suspend message or a terminate message to the application process 106 to confirm the suspend or terminate action with the application process 106. In more definite terms, if task completion message does not have info on the re-execution time, the central management process 105 will issue the terminate message to notify the application process 106 that the application process 106 should terminate execution. However, if the task completion message includes the re-execution time message, the central management process 105 will issue a suspend message to the application process 106. The difference to this is that if the application process has been terminated and if there is a need to re-execute or reactivate the terminated application process 106, the terminated application process 106 would once again need to go through the process of initial execution and request the kernel space for distribution of new system resources. However, if the application process 106 had been suspended, the application process 106 is only being temporarily stopped for a period of time. In this period of time of suspension, the system resources once occupied by the suspended application process 106 may be released and redistributed to other application processes 106 (ex. the kernel space may utilize swapping techniques to temporarily save the suspended application process 106 from the virtual memory into the hard drive, and then return the suspended application process 106 from the hard drive back into the virtual memory when it needs to be re-executed).

Then, the application process 106 would need to accept the suspend message before preparing to carry out the suspend action. After the application process 106 confirms acceptance to the suspend message, the central management process 105 will save the task completion message it received into a database. In the present embodiment, the database is preferably stored in the storage unit 109. However, in other different embodiments, the database may also be stored in a data structure or in another computer system external to the electronic device 100 (ex. by use of the Internet to store the task completion message in a database in another system). Through this design, the system resources occupied by the suspended or terminated application process 106 may be released by the kernel space to decrease the usage of the system resources in order to effect conservation of energy. However, had the application process 106 in the above example rejected the suspend or terminate message issued from the central management process 105, the central management process 105 would not save the task completion message.

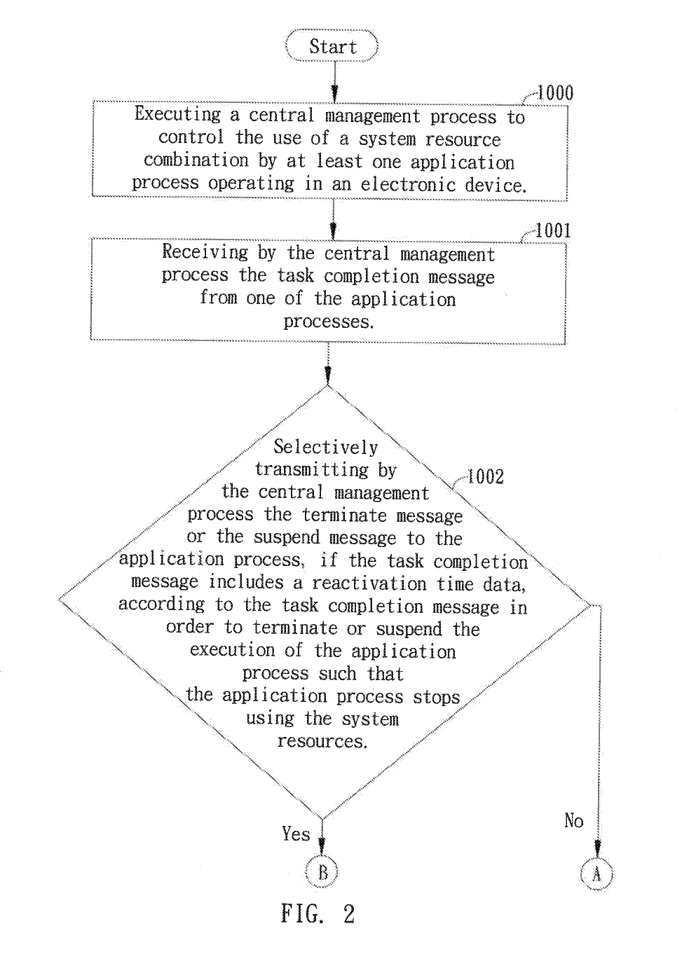

FIG. 2 is a flowchart diagram illustrating the system resource conserving method. As shown in FIG. 2, in the present embodiment, step 1000 includes executing the central management process to control the use of system resource combination 107 by at least one application process 106 operating in the electronic device 100. In more definite terms, when the electronic device 100 is in the operating state, the operating system 101 in the electronic device 100 will preferably first execute the central management process 105 in the user space 103. In this manner, the management process 105 may provide control and management services of other application processes 106.

Step 1001 includes receiving by the central management process the task completion message from one of the application processes 106. In more definite terms, when the application process 106 is initially executed in the user space, the application process 106 will send a system call to the kernel space 102 to request the privilege to use a portion of the combination of system resources. After the application process 106 has been distributed a portion of the combination of system resources to use, the application process 106 will proceed with performing its task. For instance, if the electronic device 100 is a network router and the network router executes a ntp-client process, the ntp-client process will request for privilege rights to use the internet system resources of the electronic device 100. When the ntp-client process has completed the task or purpose of transmitting/receiving data through Internet means, the ntp-client process will transmit the task completion message to the central management process 105 to inform thereof that the ntp-client process (application process 106) has completed its task.

Step 1002 includes selectively transmitting by the central management process 105 the terminate message or the suspend message to the application process 106, if the task completion message includes a reactivation time data, according to the task completion message in order to terminate or suspend the execution of the application process 106 such that the application process 106 stops using the system resources. In continuing with the ntp-client example above, when the central management process 105 receives the task completion message from the ntp-client process, the central management process 105 will decide whether to transmit the terminate message or the suspend message to the ntp-client process according to the task completion message. In more definite terms, if the task completion message includes the reactivation time info, the central management process 105 will transmit the suspend message to the ntp-client process. The task completion message may include the reactivation time info of the application process 106 or any other data related to the application process 106. The reactivation time info is defined as the next scheduled time for execution of the application process 106 in the operating system 101. If it is discovered that the task completion message does not include the reactivation time info, this would mean that the application process 106 has completed its final task and would need to be terminated in its execution in the user space 103 to allow the release of occupied system resources. That is, if the task completion message does not include the reactivation time info, the central management process 105 will transmit the terminate message to the ntp-client process.

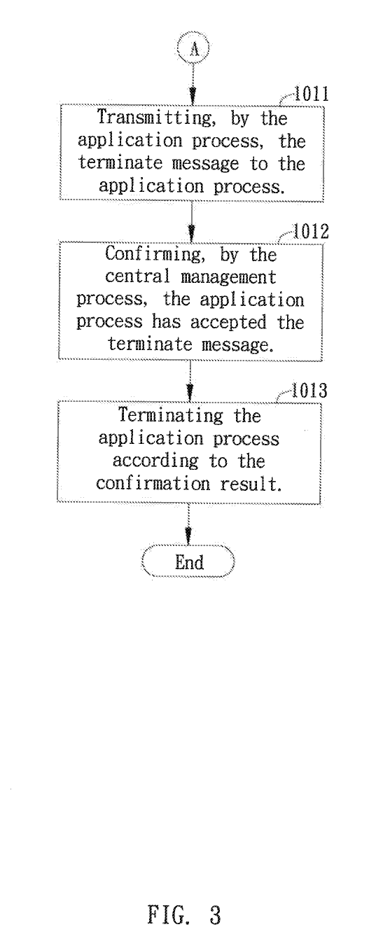

FIG. 3 is a flowchart diagram illustrating the termination of application process 106. As shown in FIG. 3, step 1011 includes the central management process 105 transmitting the terminate message to the application process 106. When the application process 106 receives the terminate message, the application process 105 will need to decide whether to accept the terminate message. In more definite terms, a program may have multiple application processes 106 executing in the user space 103. If one of the application process 106 accepts the terminate message without regard to how the termination of that particular process 106 will have on the operation of the program, it could cause unforeseeable consequences. For instance, continuing the above ntp-client example, if the ntp-client senselessly accepts the terminate instruction and the services of the ntp-client is needed by a program after the termination, the program needing the services of the ntp-client would not be able to complete its goal since the ntp-client has already been terminated in its execution. In the present embodiment, every application process 106 has the right to accept or reject the terminate message issued by the central management process 105 in order to prevent the above-mentioned problem from occurring. Step 1012 includes the central management process 105 confirming the application process 106 has accepted the terminate message. In the present embodiment, the application process 106 can reply with a confirmation message to the central management process 105. However, in other different embodiments, the central management process 105 may determine whether or not the application process 106 has accepted the terminate message according to a default wait time (i.e. application process 106 does not reply or does not reply within the default wait time). Then, step 1013 includes ending or terminating the application process 106 according to the confirmation result.

However, when the step 1002 has confirmed that the task completion message includes the reactivation time info, it means that afterwards the application process 106 will still be called upon to run tasks. Therefore, application process 106 should not be terminated and instead should be temporarily suspended.

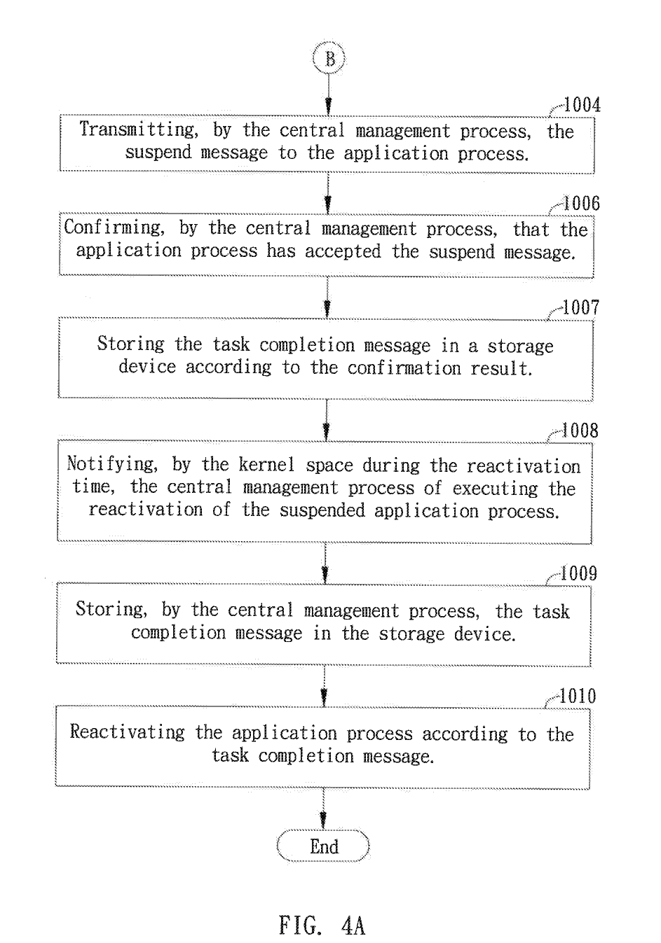

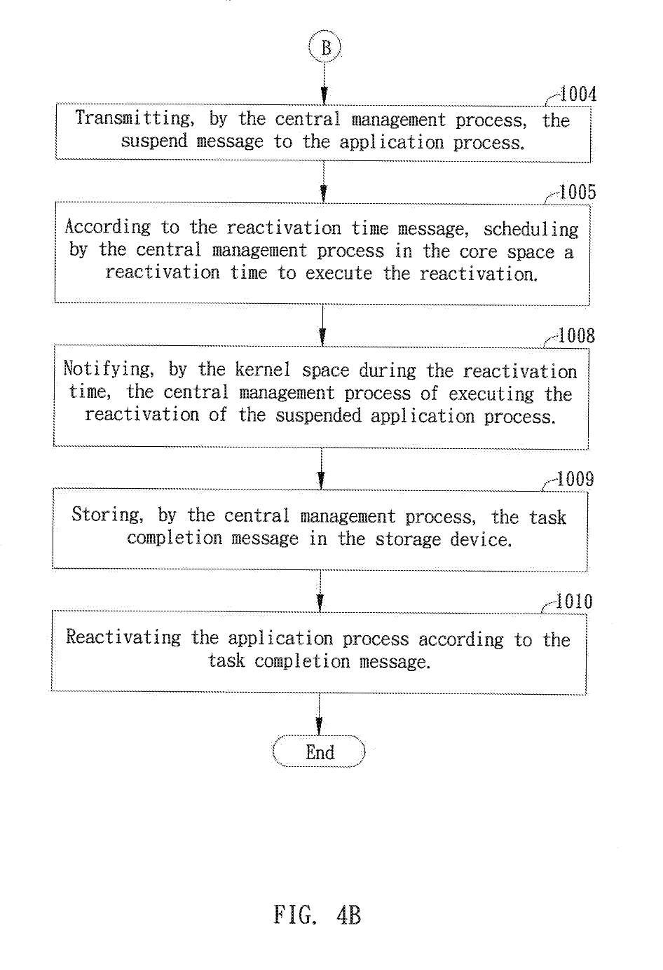

FIG. 4A is a flowchart of suspending and reactivating the application process 106. As shown in FIG. 4A, upon discovering that the task completion message includes the reactivation time info, step 1004 will be carried out. Step 1004 includes the central management process 105 transmitting the suspend message to the application process 106. Then, step 1006 will be implemented, wherein step 1006 includes confirming by the central management process 105 that the application process 106 has accepted the suspend message. The confirmation method involved in this step is similar to the confirmation of the terminate message step of above. Step 1007 includes storing the task completion message in a storage device according to the confirmation result, wherein the task completion message includes a process reactivation info for the central management process 105 to confirm the application process 106 has accepted the suspend message. Step 1008 includes notifying, by the kernel space, at the reactivation time the central management process 105 of executing the reactivation of the suspended application process. Step 1009 includes retrieving, by the central management process 105, the task completion message from the storage device. Step 1010 includes reactivating the application process according to the task completion message.

FIG. 4B is another embodiment of FIG. 4A. In the present embodiment, step 1005 replaces step 1006 and step 1007. Step 1005 includes scheduling a reactivation time in the kernel space 102 according to the reactivation time info to perform reactivation. The biggest difference between FIGS. 4A and 4B is that the flowchart of FIG. 4B describes the central management process 105 completely being the sole interface between application processes 106 and the kernel space 102. By way of the system resources that central management process 105 can control, by having the application processes 106 go through the central management process 105, the central management process 105 can more easily control and monitor the suspension, termination, and reactivation times as well as the system resources used by the application processes 106.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A system resource conserving method for managing an application process executing on an electronic device, wherein the electronic device has a combination of system resources, the method comprising:
(A) executing a central management process for managing utilization of the system resource by the application processes;
(B) receiving by the central management process a task completion message from one of the application processes; and
(C) selectively transmitting by the central management process a terminate message or a suspend message to the application process according to the task completion message in order to terminate or suspend the execution of the application process such that the application process stops using the system resources.

2. The system resource conserving method of claim 1, wherein the task completion message includes a reactivation time data; in step (C), the central management process transmits the suspend message to the application process when the task completion message includes the reactivation time data.

3. The system resource conserving method of claim 2, further comprising:
scheduling in a kernel space with the central management process according to the reactivation time data to execute reactivation at a reactivation time.

4. The system resource conserving method of claim 2, further comprising:
confirming with the central management process that the application process has accepted the suspend message; and
storing the task completion message in a storage device according to the confirming result; wherein the task completion message includes a process reactivation data.

5. The system resource conserving method of claim 4, further comprising:
notifying the central management process by the kernel space at the reactivation time of proceeding with the reactivation of the suspended application process;
retrieving the task completion message in the storage module by the central management process; and
reactivating the application process according to the task completion message.

6. The system resource conserving method of claim 1, wherein in step (C), when the task completion message does not include a reactivation time data, the central management process transmits the terminate message to the application process.

7. The system resource conserving method of claim 6, further comprising:
confirming by the central management process that the application process has accepted the terminate message; and
ending the application process according to the confirming result.

8. An operating system for use in an electronic device, wherein the electronic device includes a combination of system resources, the operating system comprising:
a user space, wherein at least an application process and a central management process are executed in the user space, wherein the central management process receives from one of the application process a task completion message and, according to the task completion message, selectively transmits a terminate message or a suspend message to the application process to terminate or suspend the execution of the application process;
a kernel space distributing a portion of the system resource combination for the application process to use, wherein according to the terminate message or the suspend message the application process notifies the kernel space of the termination or suspension of the application process so that the portion of the system resource combination in use by the application process is released.

9. The operating system of claim 8, wherein the electronic device includes a computer, a router, a mobile cellular phone, and an embedded system.

10. The operating system of claim 8, wherein the system resource combination includes a random access memory, a hard drive, a network interface controller; and a virtual memory.

11. The operating system of claim 8, wherein the combination of system resources includes a memory or a data structure.
